(19) United States
(12) Patent Application Publication
(10) Pub. No.: US 2004/0181905 A1
(43) Pub. Date: Sep. 23, 2004

(54) Retractable handle of luggage having two adjacent pulling rods

(75) Inventors: Shih Yu Chang, Taipei (TW); Chung-Hsien Kuo, Pan-Chiao City (TW)

Correspondence Address: SHIH YU CHANG, Wu Ku Industrial Park, No. 29, Wu Chuang 3rd Rd., Wu Ku Hsiang, Taipei County, 248, TW

(73) Assignee: CHAW KHONG TECHNOLOGY CO., LTD., Wu Ku Hsiang (TW)

(21) Appl. No.: 10/805,185

(22) Filed: Mar. 22, 2004

(30) Foreign Application Priority Data
Mar. 22, 2003 (CN) 03241542.7

(51) Int. Cl. A47J 45/00

(52) U.S. Cl. 16/110.1

(57) ABSTRACT

A retractable handle of luggage comprises a T-shaped member having a top central opening, an intermediate hollow neck, and a lower hollow enlargement secured to two sliding tubes of two adjacent pulling rods, a spring depressible push button disposed in the opening of the T-shaped member, a revised Y-shaped actuated member disposed within enlargement, being operatively secured to the push button, and two connecting rods each having top end disposed in the enlargement and the bottom end coupled to a locking device. Pressing the push button will push down the actuated member to contact and push down the connecting rods for unlocking the locking devices.

### BACKGROUND OF THE INVENTION

1. Field of The Invention

The present invention relates to retractable handle of a wheeled luggage case and more particularly to a T type handle grip having two adjacent pulling rods extended upwardly from about a central portion of the rear side of luggage bottom board.

2. Description of Related Art

Conventionally, a retractable handle of a wheeled luggage case having a single pulling rod has a T-shaped handle. Such is disclosed in U.S. Pat. No. 6,434,790. For maintaining structural strength of the handle, the single pulling rod typically has a diameter at least two times larger than that of pulling rod of the popular n-shaped handle. This can undesirably consume material.

Moreover, a locking operational mode of the T-shaped pulling rod is different from that of the n-shaped handle. Typically, the former is implemented in a detent mode and the later is implemented in a locking mode which is much advantageous over the former. As far as I am aware, the locking operational technique implemented in a detent mode have had no market acceptance. Thus, the need for improvement in both the T-shaped pulling rod and the locking operational technique thereof still exists.

### SUMMARY OF THE INVENTION

It is an object of the present invention to provide a revised Y-shaped actuated member for retractable handle system of a luggage case wherein a single one pushing force applied on the T-type handle grip will enable two arms of revised Y-shaped actuated member to readily unlock the locking devices of the two connecting rods, to thereby simplify the configuration of the retractable handle.

It is another object of the present invention to provide a connecting member disposed in the enlargement, for easily assemblying the handle grip and the connecting rods of retractable handle system of a luggage case.

It is a further object of the present invention to provide a retractable handle system of a luggage case comprising an T-shaped member including an upper grip member having a top central opening, and a lower body including a top plate coupled to the upper grip member and having a central hole, an intermediate hollow neck, and a lower hollow enlargement secured to two sliding tubes of two adjacent pulling rods; a spring depressible push button disposed in the opening of the T-shaped member and including a post having inner threads extended down through the central hole of the top plate and the neck; a revised Y-shaped actuated member disposed within enlargement, the revised Y-shaped actuated member being secured to the post; and two connecting rods each having top end disposed in the enlargement and the bottom end coupled to a locking device, whereby pressing the push button will push down the revised Y-shaped actuated member to contact and push down the bottom ends of the connecting rods for unlocking the locking devices and enabling a pulling of the handle grips thereafter.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of retractable handle of luggage case having two adjacent pulling rods according to the invention, where the pulling rods are extended to a maximum length;

FIG. 2 is an exploded view of the handle in FIG. 1;

FIGS. 3 and 4 are longitudinal sectional views of an upper portion of the handle for illustration nonoperating and operating positions thereof respectively; and

FIG. 5 is a view similar to FIG. 1, where the pulling rods are retracted to a minimum length.

### DETAILED DESCRIPTION OF THE PREFERRED EMBODIMENTS

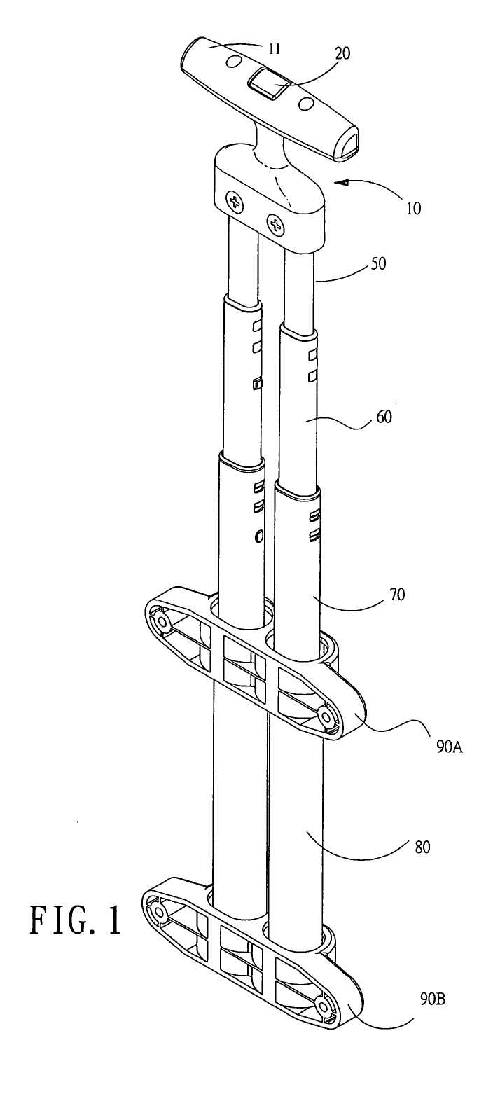

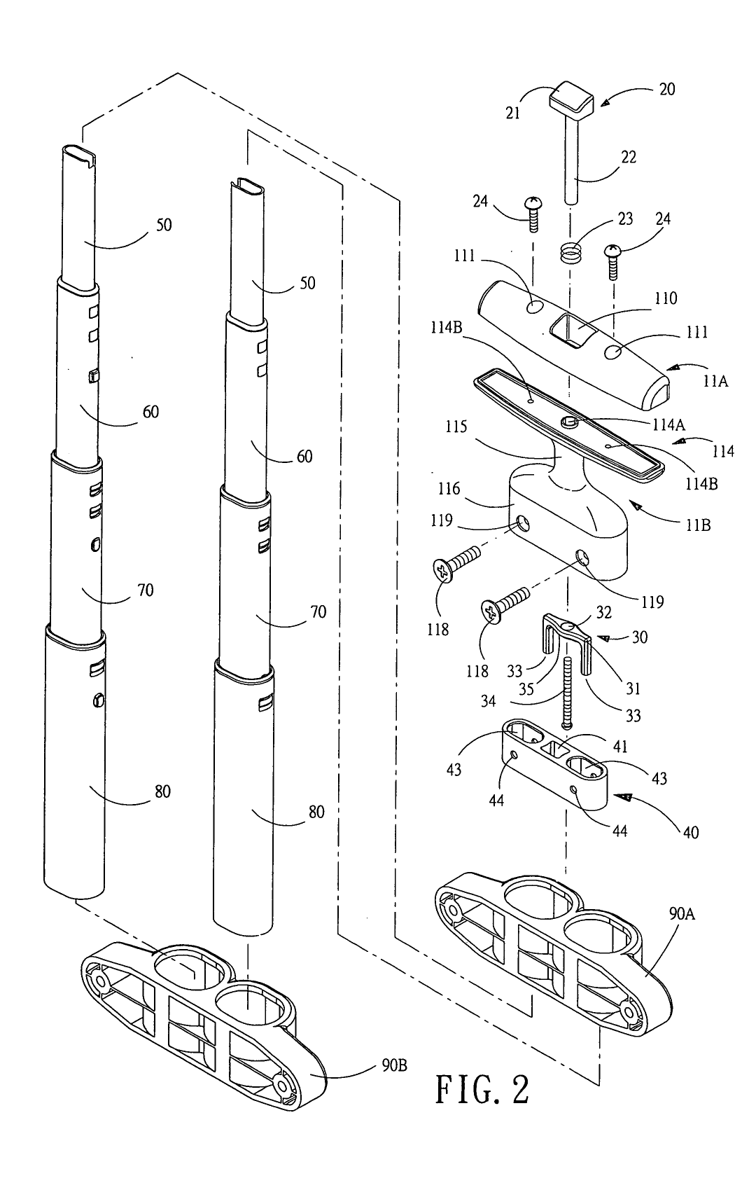

Referring to FIGS. 1 to 5, there is shown a retractable handle system of a wheeled luggage case constructed in accordance with the invention. The handle system comprises an T-shaped handle 10 including an upper grip member 11A including a top central opening 110 and two apertures 111 at both sides of the opening 110, and a lower body 11B including a top plate 114 having a central hole 114A and two apertures 114B at both sides of the hole 114A, an intermediate neck 115, and a lower enlargement 116 including an interior space 117 and two holes 119 through front and rear sides; a push button 20 including a trigger member 21 disposed in the opening 110, a post 22 having inner threads extended downwardly from the trigger member 21 through the neck 115 of the body 11B, a spring 23 put on the post 22 and mounted in the opening 110, and two screws 24 driven through the apertures 111 into the apertures 114B for fastening the upper grip member 11A and the plate 114 together; a revised Y-shaped actuated member 30 disposed within the space 117 and including an n-shaped member 31 having a top central through hole 32 and two side arms 33, and a screw 34 driven through the hole 32 into the post 22 for threadedly securing the revised Y-shaped actuated member 30 to the push button 20; a connecting member 40 including a central channel 41, two side channels 43 with upper portions of two upper sliding tubes 50 disposed therein, and two holes 44 each laterally passed the side channel 43 such that two screws 118 can be driven through the holes 119, the upper sliding tubes 50, and the holes 44 for fastening the body 11B, the connecting member 40, and the upper sliding tubes 50 (i.e., two pulling rods) together.

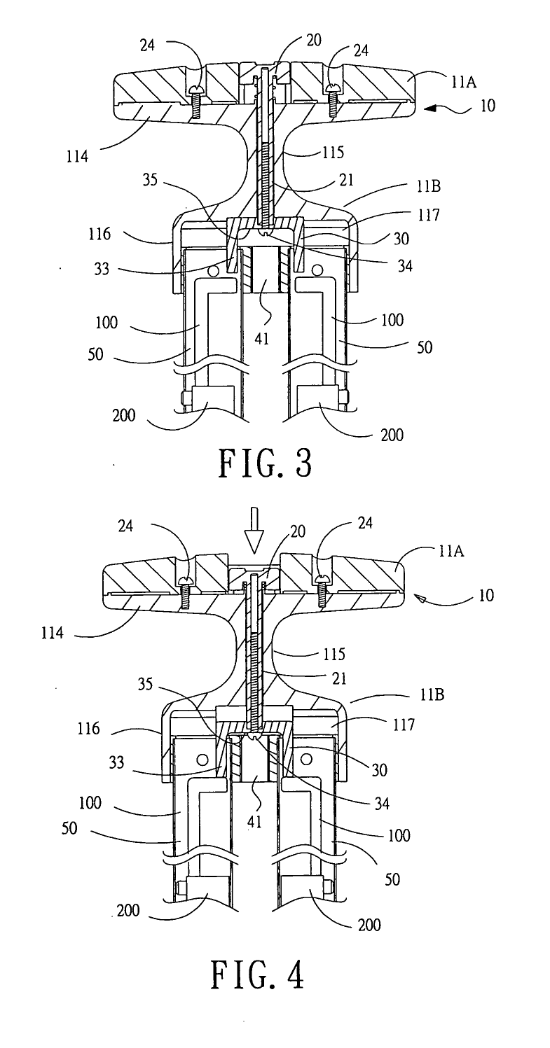

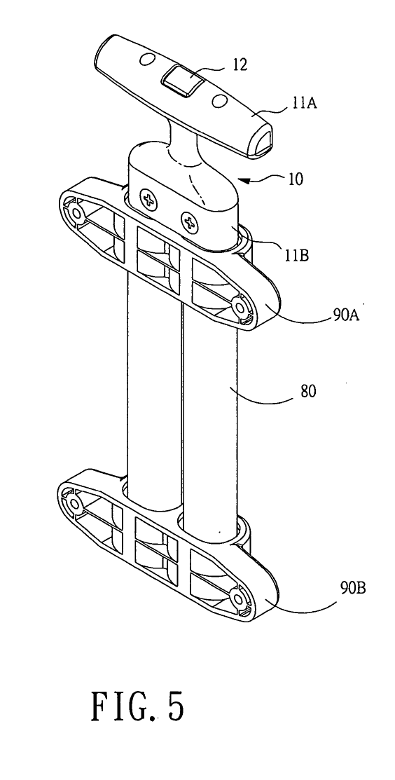

In addition to the upper sliding tube 50, the pulling rod further comprises a bottom support tube 80 secured between a top socket 90A and a bottom socket 90B on a bottom of luggage case (see FIG. 5), a lower sliding tube 70 slidable along and within the support tube 80, and an intermediate sliding tube 60 slidable along and within the lower sliding tube 70. Also, the upper sliding tube 50 is slidable along and within the intermediate sliding tube 60. Moreover, a pair of connecting rods 100 (see FIGS. 3 and 4) each has a top end disposed in the side channel 43 and the bottom end coupled to a locking device 200. As shown in FIGS. 3 and 4, a pressing of the push button 20 (i.e., the trigger member 21) will push two side arms 33 of the revised Y-shaped actuated member 30 down to contact and push down top ends of both connecting rods 100 until a bottom 35 of the transverse section of the revised Y-shaped actuated member 30 is stopped by a top of the central channel 41. As an end, the locking devices 200 are unlocked for enabling a pulling of the handle grips thereafter. In other embodiments, the upper grip member 11A and the body 11B are integrally formed. Moreover, the enlargement 116 is directly secured to the upper sliding tubes 50, i.e., the connecting member 40 is eliminated. Further, the post 22 and the revised Y-shaped actuated member 30 are formed integrally to form an integral revised Y-shaped actuated member. It will be readily understood that the most important feature of the present invention is to create a unique revised Y-shaped actuated member 30 including an n-shaped member 31 and a screw 34 combined together as one unit of three-way actuated member, to enable that one applying a pushing force on the push button 20 will have the two arms of the actuated member 30 actuated a locking device 200 at the bottom of both connecting rods 100 to be unlocked for enabling the pulling of the handle grip. This is not only to have a single one pushing force on the T-type handle grip to enable two arms of revised Y-shaped actuated member to unlock the locking devices of the two connecting rods, but also to simplify the configuration of the retractable handle.

While the invention herein disclosed has been described by means of specific embodiments, numerous modifications and variations could be made thereto by those skilled in the art without departing from the scope and spirit of the invention set forth in the claims.

What is claimed is:

1. A retractable handle system of a luggage case, comprising:
an T-shaped member having a top central hole, an intermediate hollow neck, and a lower hollow enlargement;
a spring depressible push button disposed in the top central opening of the T-shaped member;
a revised Y-shaped actuated member disposed within enlargement, being operatively connected to the push button; and
two connecting rods each having a top end disposed in the enlargement and a button end operatively coupled to a locking device,
whereby pressing the push button will push down the actuated member to contact and push down the top ends of the connecting rods for unlocking the locking devices and enabling a pulling of the handle grips thereafter.

2. The retractable handle system of claim 1, wherein the T-shaped member comprises an upper grip member having a top central opening, and a lower body including a top plate coupled to the upper grip member.

3. The retractable handle system of claim 1, wherein the push button comprises a post having inner threads extended down through the central hole of the top plate and the hollow neck of the lower body.

4. The retractable handle system of claim 1, further comprising a connecting member disposed in the enlargement, the connecting member including a central channel and two side channels with upper portions of the sliding tubes fastened therein.

5. The retractable handle system of claim 1, wherein the upper grip member and the lower body are integrally formed.

6. The retractable handle system of claim 1, wherein the post and the actuated member are formed integrally.
